(19) United States
(12) Patent Application Publication
(10) Pub. No.: US 2021/0162569 A1
(43) Pub. Date: Jun. 3, 2021

(54) TOOL WITH MAGNETIC ELEMENT

(71) Applicant: Hewlett-Packard Development Company, L.P., Spring, TX (US)

(72) Inventor: David B Larson, Boise, ID (US)

(21) Appl. No.: 17/047,968

(22) PCT Filed: Jun. 28, 2018
(86) PCT No.: PCT/US2018/039937

§ 371 Date: Oct. 15, 2020

(51) Int. Cl. B25B 11/00

(52) U.S. Cl. CPC B25B 11/002

(57) ABSTRACT

An example tool is provided that includes an outer housing and an inner housing. The inner housing includes a magnetic element and is structured to travel at least partially within the outer housing under bias of a biasing mechanism. In addition, the inner housing can travel from a retracted position to an extended position. In the extended position, the magnetic element abuts or at least partially occupies a void defined by the outer tip.

### BACKGROUND

Tools with active magnetic tips facilitate the picking up, positioning and placing of magnetic objects in various environments (e.g., manufacturing environment). Some tools are designed to be “grabbers” (e.g., tools to pick up screws that drop within products during repair). Other tools are designed to be “placers” (e.g. tools that terminate magnetic attraction in order to release metal debris).

### BRIEF DESCRIPTION OF THE DRAWINGS

FIG. 1A and FIG. 1B are sectional views of an example tool that can position a magnetic element between a retracted and extended position.

FIG. 2A illustrates an isometric view of an example tool.

FIG. 2B illustrates a cross-sectional view of an example tool with a magnetic element in a retracted position.

FIG. 2C illustrates a cross-sectional view of an example tool with a magnetic element in an extended position.

FIG. 2D illustrates an isometric view of an outer housing depicted in the example of FIG. 2C.

FIG. 2E illustrates a closeup view of an outer tip of the outer housing depicted in the example of FIG. 2D, according to a first variation.

FIG. 2F illustrates a closeup view of an outer tip of the outer housing depicted in the example of FIG. 2D, according to a second variation.

FIG. 2G illustrates an isometric view of an inner housing depicted in the example of FIG. 2C.

FIG. 2H illustrates a closeup view of a magnetic element of the inner housing depicted in the example of FIG. 2G.

FIG. 3 illustrates an example method for manipulating an example tool.

### DETAILED DESCRIPTION

Examples pertain to a user manipulated tool that provides fine control in picking up and placing various types of magnetic components or objects.

According to some examples, the tool includes an outer housing and an inner housing. The inner housing is structured to travel at least partially within the outer housing from a retracted position to an extended position. Further, the inner housing travels within the outer housing from the retracted position to the extended position under bias of a biasing mechanism. In the extended position, a magnetic element of the inner housing abuts or at least partially occupies a void defined by the outer tip.

With reference to examples as described, the term “magnetic” in reference to an object (e.g., “magnetic element”) of the tool, is intended to mean that the object has, or otherwise can generate, a magnetic field of sufficient strength to cause at least one of attachment or repulsion by another object that emits a magnetic field when the two objects are positioned in sufficient proximity to one another.

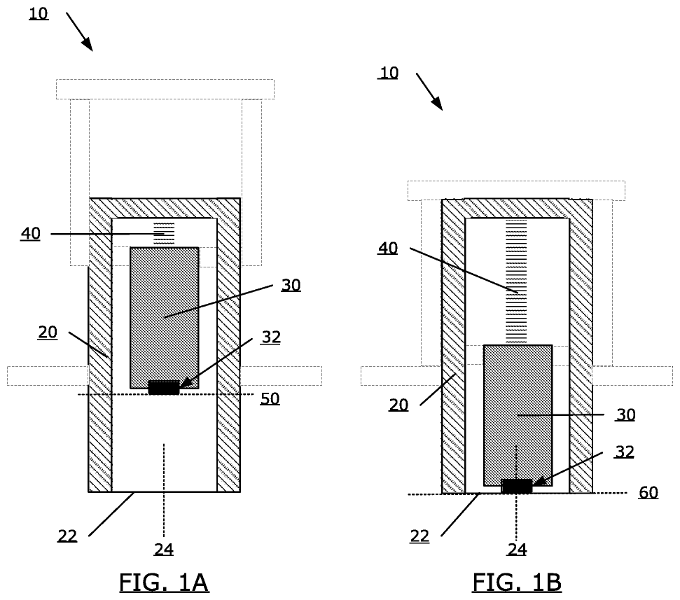

FIG. 1A and FIG. 1B are sectional views of an example tool that can position a magnetic element between a retracted and extended position. With reference to FIG. 1A, a tool 10 can be manipulated by a user to pick up, position and/or orient other magnetic objects (e.g., metallic objects).

In examples, the tool 10 includes an outer housing 20, an inner housing 30, and a biasing mechanism 40. The inner housing can include, or otherwise be provided with a magnetic element 32 at a distal end. The outer housing 20 and the inner housing 30 can be concentrically aligned, allowing for at least a section of the inner housing 30 to move relative to the outer housing 20. In an example, the inner housing 30 can travel within the outer housing 20, under bias of the biasing mechanism 40, between a retracted position 50 and an extended position 60. The tool may include a combination of grip or retention mechanism to enable the user to move the inner housing 30 relative to the outer housing. The manipulation of the inner housing 30 can be by way of application of force (e.g., user pressing with hand) to initiate the inner housing 30 to travel to the extended position 60, and by release of the applied force (e.g., user relaxing hand) to enable the inner housing 30 to return to the retracted position 50. When the inner housing is in the retracted position 50, the magnetic element 32 is positioned away or distally from an outer tip 22 of the outer housing 20. When the inner housing is in the extended position 60, the magnetic element 32 is positioned within or near a void 24 of the outer tip 22. In this position, the magnetic field emitted from the magnetic element 32 can attract other objects to the outer tip 22 of the outer housing 20.

According to examples, the magnetic element 32 can be a permanent magnet, such as formed by rare earth materials. In variations, the magnetic element 32 can be an electromagnetic magnet that is activated by a charge, such as may be provided by a battery housed within the tool 100. Still further, in implementations, the inner housing 30 can position the magnetic element 32 so that a surface of the magnetic element 32 is external, or externally exposed to the tool at the outer tip 22. In such a configuration, the magnetic element 32 can directly contact an object that is being picked up or moved.

In other variations, the magnetic element 32 can be slightly recessed within the void 24 of the outer tip 22 so that an attracted object may contact a periphery of the outer tip 22, rather than directly contacting the magnetic element 32. As another variation, the magnetic element 32 can be formed from magnetic material that is encased by another structure that is integrated with the inner housing 30. In such variations, the magnetic element 32 can be extended to, or through the void 24 of the outer tip 22, so that a surface of the encased structure is exposed at the outer tip 22 to attract objects.

The biasing mechanism 40 can be structured within the outer housing 20 to apply an increasing bias against the inner housing 30 as the inner housing 30 is moved to the extended position 60, with the maximum bias being applied when the inner housing 32 is in the extended position 60. Likewise, the biasing mechanism 40 can be relaxed to lessen the bias on the inner housing 30 as the inner housing 30 is returned to the retracted position 50, with no bias (or minimal bias) being applied against the inner housing 30 when in the retracted position 50.

In examples, the biasing mechanism 40 can be implemented as one or multiple springs, such as an extension spring, torsional spring or a compression spring. As shown by some examples, the biasing mechanism 40 can be implemented using an extension spring that connects the inner housing to an interior surface of the outer housing 20. In such a configuration, the extension spring biases as the inner housing 30 is moved towards the extended position 60, and the extension spring relaxes as the inner housing 30 is moved towards the retracted position 50. In variations, the biasing mechanism 40 can be implemented as one or multiple compression springs (e.g., tubular springs that surround the inner housing 30 or which lay adjacent to the inner housing) that resist inward movement of the inner housing 30. As still another variation, the biasing mechanism 40 can be formed from elastic materials, such as deformable materials or materials that elongate to provide bias.

In another variation, the outer tip 22 can be structured to include an end wall, without a void that exposes the interior of the tool 10 and the magnetic element 32. In such an example, the magnetic element 32 can abut against an interior of the end wall of the outer tip 22. In this position, other magnetic objects can be attracted or repulsed to the outer tip 22, with attracted objects being attached to the end wall or surface of the outer tip 22.

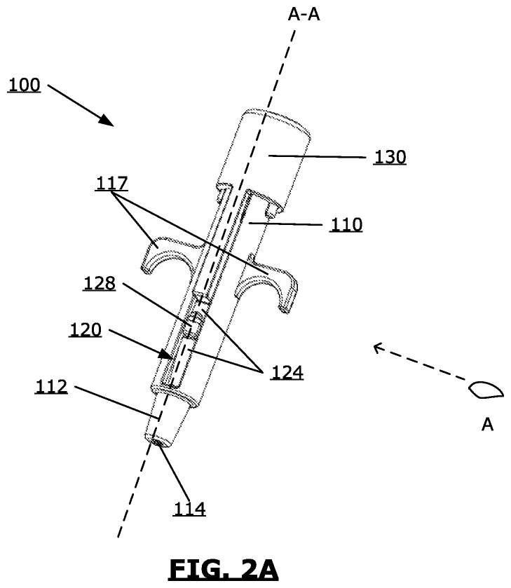

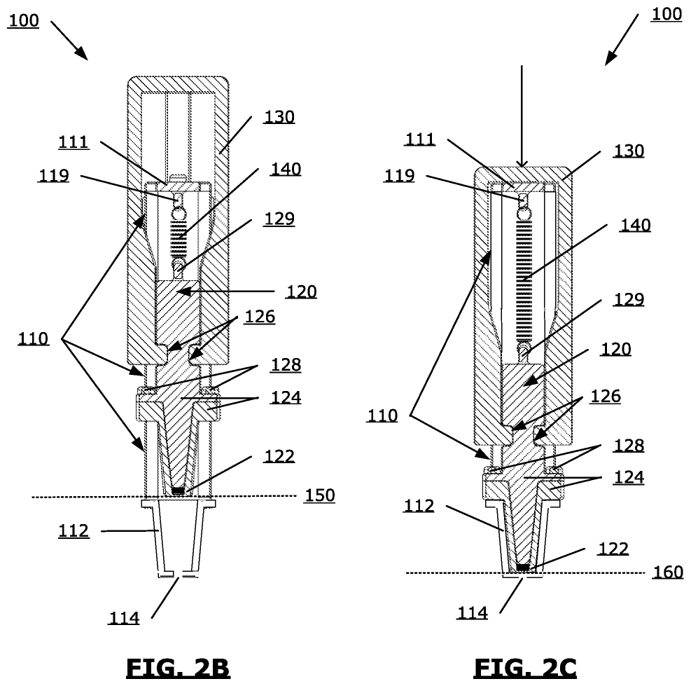

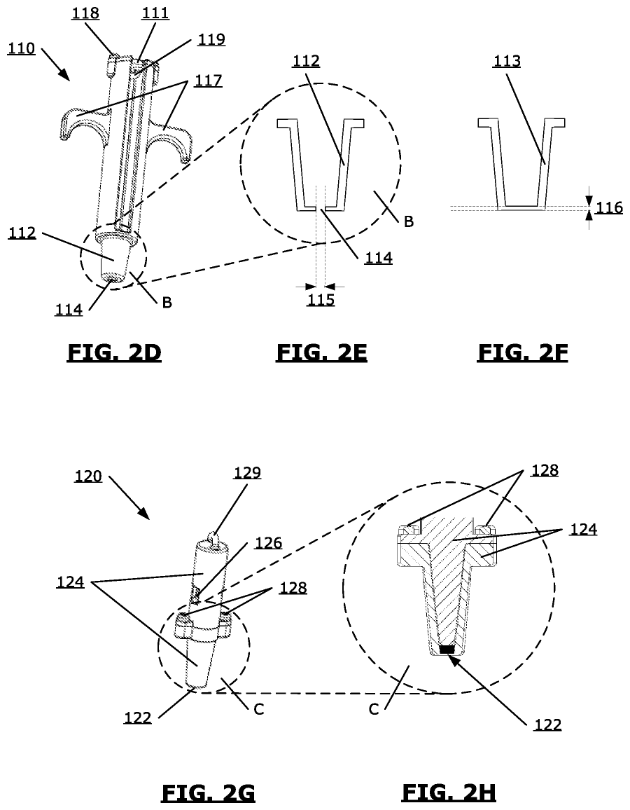

FIG. 2A is an isometric view of an example tool 100. The example tool 100 includes an outer housing 110, an inner housing 120 and an end section 130. The inner housing 120 can be structured to travel within the outer housing 110 by way of application of force to the end section 130. In some examples, the tool 100 can be held between a palm or thumb of the user at the top section 130 and the fingers of the user at the flanges 117. The top section 130 is connected to the inner housing 120 so that when the user applies force to the top section 130, both the top section 130 and the inner housing 120 (and accordingly a magnetic element of the inner housing 120) move in unison. The flanges 117 are affixed to the outer housing 110. In this way, the fingers of the user at the flanges 117 stay in a fixed position relative to the outer housing 110 as the palm or thumb of the user (along with the top section 130 and the inner housing 120) move relative to the outer housing 110 during an application of force by the user.

A distance from a top surface of the top section 130 and a bottom surface of the outer tip 112 defines a length of the tool 100. Due to the handheld characteristic of the tool 100, a distance from the top surface of the top section 130 to the flanges 117 is meant to approximate a hand size of a user (e.g., distance from palm to finger tips). A distance from the flanges 117 to the bottom surface of the outer tip 112 can vary by application. For example, some applications may prevent a user from being in close proximity to the product in which magnetic components or objects are to be placed (e.g., clean room environment), which may necessitate a longer tool. Other applications may allow or even benefit a user to be in close proximity to the product in which magnetic components or objects are to be placed, which may necessitate a shorter tool. As such, the length of the tool 100 can vary or be tailored to a particular application.

The shape of the outer tip 112 can also vary or be tailored to a particular application. In examples, the outer tip 112 can be shaped to provide increased visibility of magnetic components or objects during pick up and/or placement. As illustrated in the example of FIG. 2A, the outer tip 112 is conically shaped, although other shapes are contemplated (e.g., pyramidal, etc.). In addition, the shape of the outer tip 112 and the shape of the magnetic element of the inner housing 120 can be structured to create an interference fit between an interior surface of the outer tip 112 and an exterior surface of the magnetic element when the magnetic element is in the extended position. In variations, the shape of the outer tip 112 and the shape of the magnetic element can be structured so that, in the extended position, a clearance or gap exists between an interior surface of the outer tip 112 and an exterior surface of the magnetic element. For example, in one variation, the outer tip 112 can be conically shaped and the magnetic element can be cylindrically shaped.

FIG. 2B and FIG. 2C illustrate cross sectional views along the A-A axis and viewed from perspective A in FIG. 2A. FIG. 2B illustrates a magnetic element 122 of the inner housing 120 residing in a retracted position 150. FIG. 2C illustrates the magnetic element 122 of the inner housing 120 in the extended position 160, abutting a void 114 defined by the outer tip 112 of the outer housing 110.

The top section 130 can be structured to receive contact by a hand of the user (e.g., palm, thumb, etc.). In addition, the top section 130 can be structured to connect to the inner housing. In some examples, the top section 130 can be structured to encapsulate the outer housing 110 and also pass through the outer housing 110 in order to connect to the inner housing 120. In the example of FIGS. 2B and 2C, the top section 130 encapsulates the outer housing 110 and also passes through a side wall of the outer housing 110 on opposing sides to connect to recesses 128 positioned on corresponding opposing sides of the inner housing 120. In other examples, the end section 130 does not encapsulate the outer housing 110, but rather passes through a top wall of the outer housing 110 (e.g., lid 111) and connects to a top wall of the inner housing (e.g., surface adjacent to link 129).

When the magnetic element 122 is in the retracted position 150, an interior surface of the top section 130 is separate from an exterior surface of the lid 111 of the outer housing 110. As the magnetic element 122 travels from the retracted position 150 to the extended position 160, the separation lessens between the interior surface of the top section 130 and the exterior surface of the lid 111. In the example of FIG. 2C, when the magnetic element 122 abuts the void 114, the interior surface of the top section 130 contacts the exterior surface of the cover 111. In variations, when the magnetic element 122 abuts the void 114 in the extended position, the top section 130 can be structured so that a separation exists between the interior surface of the top section 130 and the exterior surface of the lid 111.

The tool 100 includes a spring 140. The spring 140 connects the outer housing 110 to the inner housing 120 via the links 119, 129. As the inner housing 120 travels within the outer housing 110 between the retracted position 150 and the extended position 160, the spring 140 correspondingly extends and retracts.

The spring 140 can be wound to oppose extension (e.g., extension spring). In the retracted position, the spring 140 exists under minimal or no bias. In an example, when the tool 100 is in an upright position and under no application of force by the user, the spring 140 can exist under a bias provided by a weight of the inner housing 120 and a weight of the top section 130. In such an example, the spring 140 can be configured to retain the magnetic element 122 in the retracted position 150 under the bias provided by the weight of the inner housing 120 and the top section 130.

When manipulated to the extended position 160 by an application of force by the user, the spring 140 extends and exists under additional bias. In order to maintain the magnetic element 122 in the extended position 160, the user maintains the application of force. For example, while moving magnetic components or objects from one area (e.g., staging area) to a desired location (e.g., subassembly), the user maintains the application of force (e.g., grip on the tool 100) so that the magnetic element 122 remains abutted against the outer tip 112 of the outer housing 110 in the extended position 160 and, accordingly, the magnetic components or objects remain attached to the outer tip 112 of the tool 100. A diminishment of the application of force by the user causes the magnetic element 122 to travel toward the retracted position 150 and, accordingly, causes a diminishment in a magnitude of the active magnetic force at the outer tip 112 of the outer housing 110.

FIG. 2D illustrates an isometric view of an outer housing depicted in the example of FIG. 2C. The outer housing 110 includes the lid 111, outer tip 112, void 114, flanges 117, mechanical fasteners 118 and link 119. The outer housing 110 can be formed from material that does not cause the outer housing 110 to attract or repel magnetic components or objects. In this way, when the magnetic element 122 resides in the retracted position 150, the outer housing 110 does not inadvertently pick up or repel magnetic components or objects. Further, during placement of magnetic components or objects at a desired location, the outer housing 110 does not cause the magnetic components or objects to “jump back” to the tool 100, nor does the outer housing 110 necessitate additional effort on the part of the user to remove the magnetic components or objects from the tool 100 (e.g., “wiping” magnetic components from the outer tip 112) when removing the tool 100 from the desired location.

The lid 111 provides a cover for the outer housing 110. The lid 111 can be secured to the outer housing 110 with mechanical fasteners 118 (e.g., pins, screws, etc.) that can be received by receptacles of the outer housing 110. The lid 111 can be configured to be removeable (e.g., by removing mechanical fasteners 118) to provide access to an interior area of the outer housing 110. Access to an interior area of the outer housing 110 provides the user with the option to configure and/or replace different components of the tool 100 (e.g., spring, inner housing 120, magnetic element 122, etc.). In addition, an interior surface of the lid 111 can include the link 119 that provides a point of connection for the spring 140 to attach to the outer housing 110.

FIG. 2E illustrates a closeup view of section B in FIG. 2D. The outer tip 112 can define a void 114. The void can be structured to include various shapes (e.g., circle, square, etc.). In addition, the void 114 can be sized to include various dimensions that correspond to the respective shapes (e.g., diameter, diagonal, etc.). In the example of FIG. 2E, the void 114 is a circle sized to a diameter 115. In an example, the diameter 115 of the void 114 can be sized large enough to allow a magnetic force of the magnetic element 122 to attract magnetic components or objects to the outer tip 112 when the magnetic element 122 abuts the outer tip 112, yet sized small enough to prevent the magnetic components or objects from being drawn into the outer housing 110 through the void 114 when the magnetic element 122 travels from the extended position 160 to the retracted position 150. In another example, the diameter 115 can be sized large enough to allow the magnetic element 122 to protrude through the outer tip 112 of the outer housing 110 so that magnetic components or objects can attach directly to the magnetic element 122.

In variations, an outer tip 113 can include an end wall, without a void. In this way, the outer tip 113 conceals the interior of the tool 100 and the magnetic element 122. The end wall of the outer tip 113 can be sized to a thickness 116. In an example, the thickness 116 can be sized to allow a magnetic force of the magnetic element 122 to attract magnetic components or objects when the magnetic element 122 abuts the outer tip 112. In this way, the outer tip 113 prevents magnetic components or objects from being drawn into the tool 100 as the magnetic element 122 travels from the extended position 160 to the retracted position 150, regardless of the size of the magnetic components or objects. In addition, the thickness 116 can be formed to include an entire surface of the outer tip 112, or a portion of a surface of the outer tip 112 so as to create an indent/impression (e.g., dimple) or multiple indents/impressions on the surface of the outer tip 112.

The outer housing 110 can include flanges 117. The flanges 117 enable the user to counterbalance the application of force to the top section 130 when manipulating the inner housing 120 to travel within the outer housing 110 from the retracted position 150 to the extended position 160. In addition, the flanges 117 enable the user to counterbalance the release of the applied force when manipulating the inner housing 120 to travel within the outer housing 110 from the extended position 160 to the retracted position 150. In addition, the flanges 117 can be co-located to maximize leverage and ergonomic comfort for the user. For example, a distance from the top end 130 to the flanges 117 can approximate a distance from a palm to a finger tip of a user.

FIG. 2G is an isometric view of the inner housing 120. The inner housing 120 includes a magnetic element 122, a multibody assembly 124, recess 126, mechanical fasteners 128, and link 129. The inner housing 120 moves within and aligns concentrically with the outer housing 110. The inner housing connects to the spring 140 (and hence the outer housing 110) via the link 129 positioned on a top surface of the inner housing. The recess 126 is structured to receive a portion of the top section 130 in order to connect the inner housing 120 to the top section 130.

FIG. 2H illustrates a closeup view of section C in FIG. 2D. In the example of FIG. 2H, the magnetic element is encased between components of the multibody assembly 124. The components of the multibody assembly 124 can be press-fitted and structured to provide a space at the bottom of the inner housing 120 to house the magnetic element 122. The mechanical fasteners 128 (e.g., screws, pins, etc.) secure the multibody assembly 124 together. In addition, when an application calls for the magnetic polarity of its magnetic components or objects to face a particular direction (e.g., north) when placed in a product, the magnetic element 122 can be oriented within the inner housing 120 so that the magnetic polarity of the magnetic element 122 faces the opposite direction (e.g., south).

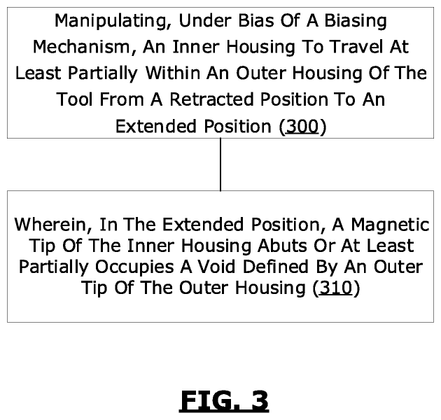

FIG. 3 illustrates an example method for manipulating a tool. The example method such as described by the example of FIG. 3 can be implemented using example tools, such as described with the examples of FIG. 1A through FIG. 1B and FIG. 2A through FIG. 2H. Accordingly, reference is made to elements described with the examples to FIG. 1A through FIG. 1B and FIG. 2A through FIG. 2H to illustrate components for implementing a block or sub-block being described in FIG. 3.

In FIG. 3, the inner housing 120 of the tool 100 can be manipulated, under bias of the biasing mechanism 140, to travel at least partially within the outer housing 110 from the retracted position 150 to the extended position 160 (300).

The tool 100, in its neutral state (e.g., without force applied to the inner housing 120 or the top section 130), resides at the retracted position 150. In the retracted position 150, the tool 100, or at least its outer tip 112, does not provide an active magnetic force to attract or repel magnetic components or objects. When a user manipulates the inner housing 120 to travel within the outer housing 110 so that the magnetic element 122 of the inner housing 120 travels towards the outer tip 112, the biasing mechanism 140 exists under bias and resists the manipulation. In this example, the user maintains or enhances the force applied in order to further manipulate the magnetic element 122 towards the outer tip 112.

In the extended position 160, the magnetic element 122 of the inner housing 120 abuts or at least partially occupies the void 114 defined by the outer tip 112 of the outer housing 110 (310). In the extended position 160, the tool 100 (at the outer tip 112) is capable of attracting and attaching to magnetic objects or components. In order to continue to hold the magnetic objects or components with the tool 100, the user maintains the application of force so that the magnetic element 122 remains in the extended position 160. On the other hand, when the user diminishes the force applied, the magnetic element 122 automatically moves away from the outer tip 112 (and towards the retracted position 150) due to the bias of the biasing mechanism 140. In this way, the active magnetic force (e.g., the magnet 123) correspondingly diminishes from the outer tip 112, and, accordingly, the tool 100 may “drop” magnetic components or objects.

In addition, when placing magnetic components or objects, the user can deliberately diminish the application of force (e.g., relaxing grip on the tool 100) when the magnetic components or objects reach a desired location. During placement, the outer tip 112 can pin down magnetic components or objects as the magnetic element 122 moves from the extended position 160 to the retracted position 150. In this way, the outer tip 112 prevents jump back or further manipulation of the magnetic components or objects by the user (e.g., wiping off, etc.) during placement.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude having rights to such combinations.

What is claimed is:

1. A tool comprising:
an outer housing including an outer tip;
an inner housing having a magnetic element, the inner housing being structured to travel at least partially within the outer housing, under bias of a biasing mechanism, from a retracted position to an extended position; and
wherein, in the extended position, the magnetic element abuts or at least partially occupies a void defined by the outer tip.

2. The tool of claim 1, further comprising a top section to receive contact from a hand of a user, the top section extending to the inner housing to cause the inner housing to travel inwards with an application of force by the hand of the user.

3. The tool of claim 2, wherein the top section is shaped and positioned to receive palm contact from the hand of the user.

4. The tool of claim 1, wherein the magnetic element is encased between components of a multibody assembly of the inner housing.

5. The tool of claim 1, wherein the outer housing includes flanges, the flanges providing a counterbalance for (i) maintaining an application of force by a user in the extended position, and (ii) diminishing the application of force by the user in transitioning from the extended position to the retracted position.

6. The tool of claim 1, wherein the biasing mechanism connects the outer housing and the inner housing.

7. The tool of claim 1, wherein the biasing mechanism is an extension spring.

8. A tool comprising:
an outer housing including an outer tip;
an inner housing having a magnetic element, the inner housing being structured to travel at least partially within the outer housing, under bias of a biasing mechanism, from a retracted position to an extended position;
a top section connected to the inner housing, the top section structured to receive an application of force by a user to cause the inner housing to travel within the outer housing;
flanges connected to the outer housing, wherein the flanges provide a counterbalance to the application of force; and
wherein, in the extended position, the magnetic element abuts or at least partial occupies a void defined by the outer tip.

9. The tool of claim 8, wherein the top section is structured to receive contact from a hand of a user.

10. The tool of claim 9, wherein the top section is shaped and positioned to receive palm contact from the hand of the user.

11. The tool of claim 8, wherein the magnetic element is encased between components of a multibody assembly of the inner housing.

12. The tool of claim 8, wherein the flanges further provide a counterbalance for diminishing the application of force by the user when transitioning from the extended position to the retracted position.

13. The tool of claim 8, wherein the biasing mechanism connects the inner housing and the outer housing.

14. The tool of claim 8, wherein the biasing mechanism is an extension spring.

15. A method for operating a tool, the method comprising:
manipulating, under bias of a biasing mechanism, an inner housing to travel at least partially within an outer housing of the tool from a retracted position to an extended position; and
wherein, in the extended position, a magnetic element of the inner housing abuts or at least partially occupies a void defined by an outer tip of the outer housing.
